(19) United States
(12) Patent Application Publication
(10) Pub. No.: US 2025/0332937 A1
(43) Pub. Date: Oct. 30, 2025

(54) STEPPED VOLTAGE BOOST CONVERTER (SVBC)

(71) Applicant: BarrellCharge Solutions, Inc., Austin, TX (US)

(72) Inventor: Murray F. Freeman, Austin, TX (US)

(21) Appl. No.: 19/169,117

(22) Filed: Apr. 3, 2025

Related U.S. Application Data
(60) Provisional application No. 63/639,777, filed on Apr. 29, 2024.

(51) Int. Cl. B60L 53/22; H02M 3/335

(52) U.S. Cl. CPC B60L 53/22; H02M 3/33569; B60L 2210/12; B60L 2210/14; B60L 2240/547

(57) ABSTRACT

Disclosed is a stepped voltage boost converter (SVBC) for use in electric vehicle supply equipment (EVSE). The converter charges a DC recipient battery (P1) with a DC source battery (BT1). The converter has a transformer (T1), buck mode circuitry, and boost mode circuitry. The transformer has a primary coupled to the source battery and a secondary coupled to the recipient battery. The buck mode circuitry, when the recipient voltage is lower than the source voltage, enables an electrical current to flow from the source battery into the primary of the transformer. The boost mode circuitry, when the recipient voltage is higher than the source voltage, enables both (a) the current to flow from the source battery into the primary of the transformer and (b) an electrical signal to be communicated to the transformer secondary to thereby increase the secondary voltage and therefore current flowing to the recipient battery.

### CLAIM OF PRIORITY

This application claims priority to and the benefit of U.S. Patent Application entitled “Stepped Voltage Boost Converter (SVBC),” filed on Apr. 29, 2024, under application No. 63/639,777, which is incorporated herein by reference in its entirety.

### FIELD OF THE INVENTION

The embodiments of the present disclosure generally relate to charging stations, or systems, for electric vehicles (EVs), and more particularly, to a stepped voltage boost converter (SVBC) that reduces the size, mass (insulation, copper, magnetics), number of taps, and ultimately cost of a converter transformer used in direct current (DC) voltage boosting.

### BACKGROUND OF THE INVENTION

Electric vehicle supply equipment (EVSE) supplies electricity to an electric vehicle (EV). Commonly called charging stations or charging docks, they provide electric power to the EV and use that to recharge the EV's batteries. EVSE systems include the electrical conductors, related equipment, software, and communications protocols that deliver energy efficiently and safely to the vehicle. In general, EVSE equipment is classified as Level 1 (120 volts AC), level 2 (240 volts, AC), and DC fast charger (480 volts DC and higher).

A DC to DC (DC/DC) converter of the prior art is shown in FIG. 1. The requisite mass, size, and cost of the DC/DC converter scale with the amount of power throughput. In voltage boost applications where the primary voltage is always lower than the secondary voltage, traditional conversion requires that all of the power being converted is processed through the device. As this required boost power gets larger, these converters can become undesirably large, heavy and expensive. Unlike line powered applications, battery-to-battery charging can require a buck phase and a boost phase in the same session. Further, expected topologies in the near future will require a battery to boost voltage ratio that can range from 1:1 to 1:3, thus requiring a multi-tap transformer.

### SUMMARY OF THE INVENTION

Embodiments of a stepped voltage boost converter (SVBC) that reduces the size, mass (insulation, copper, magnetics), number of taps, and ultimately cost of a converter transformer used in DC voltage boosting. The SVBC can be implemented in, for example but not limited to, electric vehicle supply equipment (EVSE).

One embodiment, among others, is a converter for charging a DC recipient battery with a DC source battery. The converter has a transformer, buck mode circuitry, and boost mode circuitry. The transformer has a primary and a secondary with the primary being electrically coupled to the source battery and the secondary being electrically coupled to the recipient battery. The buck mode circuitry, when the recipient voltage is lower than the source voltage, enables an electrical current to flow from the source battery into the primary of the transformer. The boost mode circuitry, when the recipient voltage is higher than the source voltage, enables both (a) the current to flow from the source battery into the primary of the transformer and (b) an electrical signal to be communicated to the transformer secondary to thereby increase the secondary voltage and therefore current flowing to the recipient battery.

Another embodiment, among others, is a method that can be broadly summarized by the following steps: providing a DC recipient battery and a DC source battery, the recipient and source batteries exhibiting different voltages; and electrically coupling the recipient battery and the source battery through a controllable current means connected with a transformer in order to transfer energy at the different voltages between the recipient and source batteries. The controllable current means exhibits an inductance that can be made lower and higher based upon when the inductance is in a boost mode and buck mode, respectively, the boost mode being when the recipient voltage is higher than the source voltage, the buck mode being when the recipient voltage is lower than the source voltage.

Other embodiments, systems, apparatus, methods, features, and advantages of the present invention will be apparent to one with skill in the art upon examination of the following drawings and detailed description. It is intended that all such additional embodiments, systems, apparatus, methods, features, and advantages be included within this disclosure, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is an example of a legacy DC/DC converter of the prior art.

FIG. 2 is an example of a circuit diagram of the stepped voltage boost converter (SVBC) in accordance with the present disclosure.

FIG. 3 is an equivalent circuit to the SVBC of FIG. 1 when in buck mode.

FIG. 4 is an equivalent circuit to the SVBC of FIG. 1 when in boost mode.

FIG. 5 is a block diagram showing an example of an implementation of the SVBC in electric vehicle supply equipment (EVSE).

### DETAILED DESCRIPTION OF PREFERRED EMBODIMENT(S)

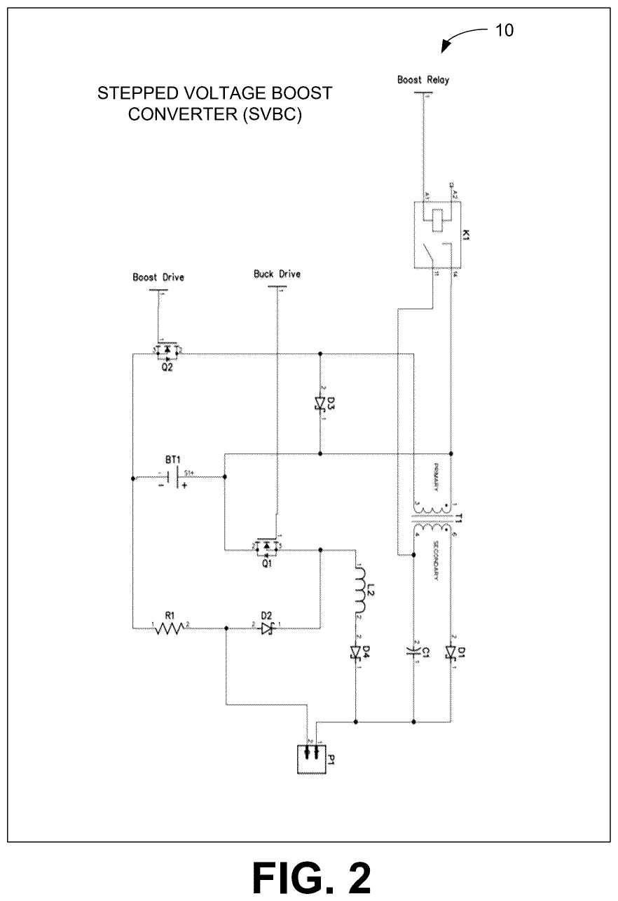

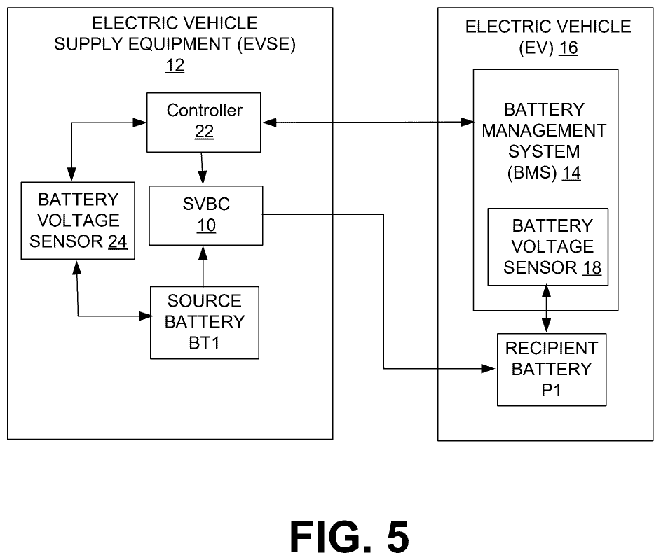

As illustrated in FIG. 2, the stepped voltage boost converter (SVBC) 10 of the present disclosure reduces the size, mass (insulation, copper, magnetics), number of taps and ultimately cost of the converter transformer used in voltage boosting. The preferred embodiment of the SVBC 10 is implemented in electric vehicle supply equipment (EVSE) 12 (FIG. 5) and adapts the voltage of a source energy storage device (for example, a battery pack) to a recipient EV battery pack voltage for the purpose of charging that EV's battery pack. Note that in this invention disclosure “battery” and “battery pack” are meant to be synonymous. Further note that the source energy storage may be connected through electronics to the electric utility grid or could be disconnected from the grid.

In most cases, the source and recipient voltages differ, and direct coupling is not possible without damage from excessive currents. The rate of charge to the target, is controlled by the amount of managed current that is provided. An inductor/transformer is needed to implement an energy conserving change from the available voltage to the target voltage at the desired current. The SVBC 10 handles both higher and lower recipient voltages relative to the source. The focus is on efficiency when the source voltage is higher, as that is the most common case (buck), but it must also handle higher recipient voltages (boost).

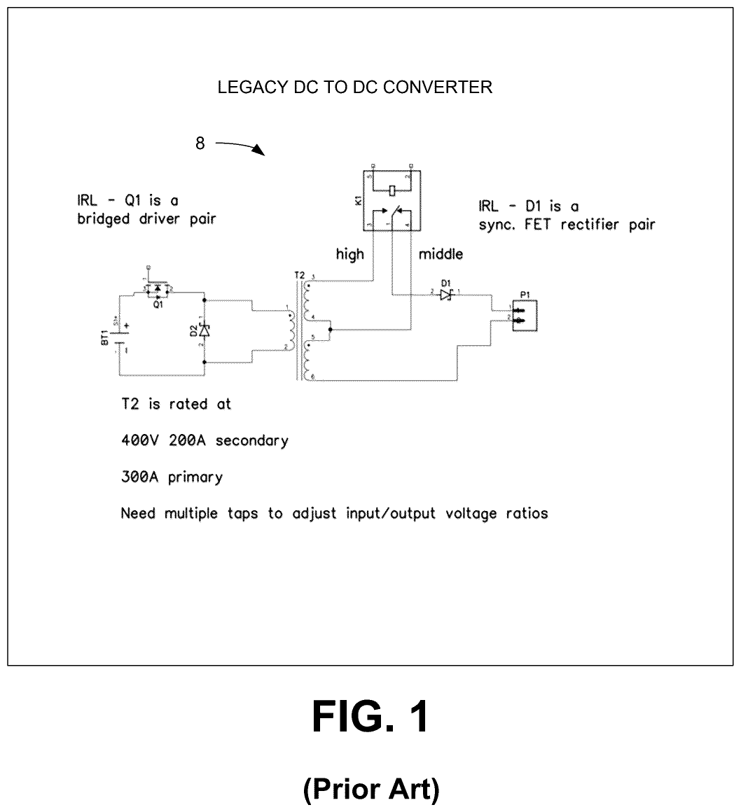

The traditional converter 8 of FIG. 1 uses an isolated primary and secondary transformer winding, multiple taps, with a switching device like a MOSFET pumping energy into the primary, which is transferred to the secondary and filtered before going to the battery. This requires multiple secondary taps and relays to handle different ratios of input to output voltages at the desired current. This SVBC 10 eliminates the need to isolate the primary and secondary.

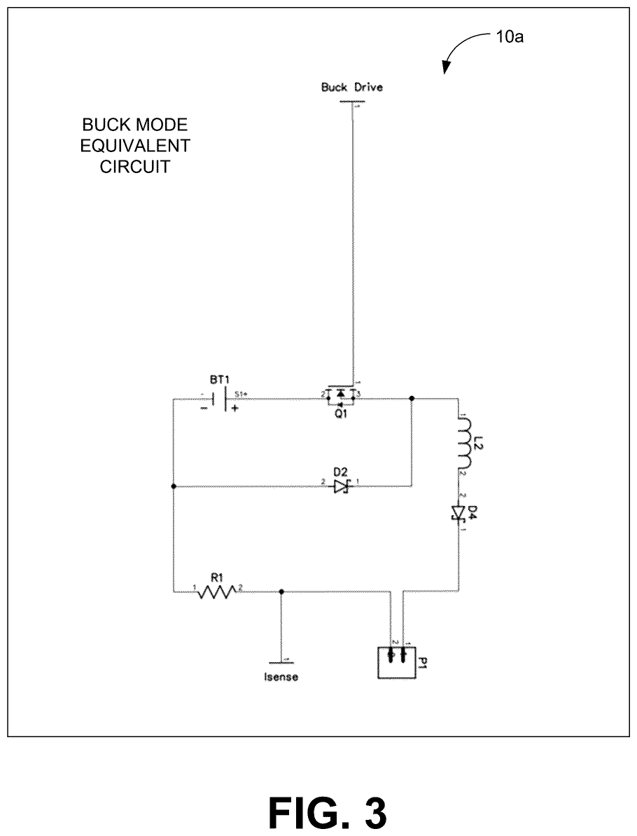

In buck mode, when the recipient voltage is lower, the left part of the circuitry associated with the SVBC 10 in FIG. 2 is inactive, and a simple buck circuit with inductor L2 handles the full current from the source to the recipient. FIG. 3 shows the equivalent circuit 10a when the SVBC 10 is in buck mode. A further embodiment allows inductor L2 to be physically merged into transformer T1 in order to further reduce cost and size of the system. For simplification in this invention disclosure, inductor L2 and transformer T1 are described as distinct separate elements.

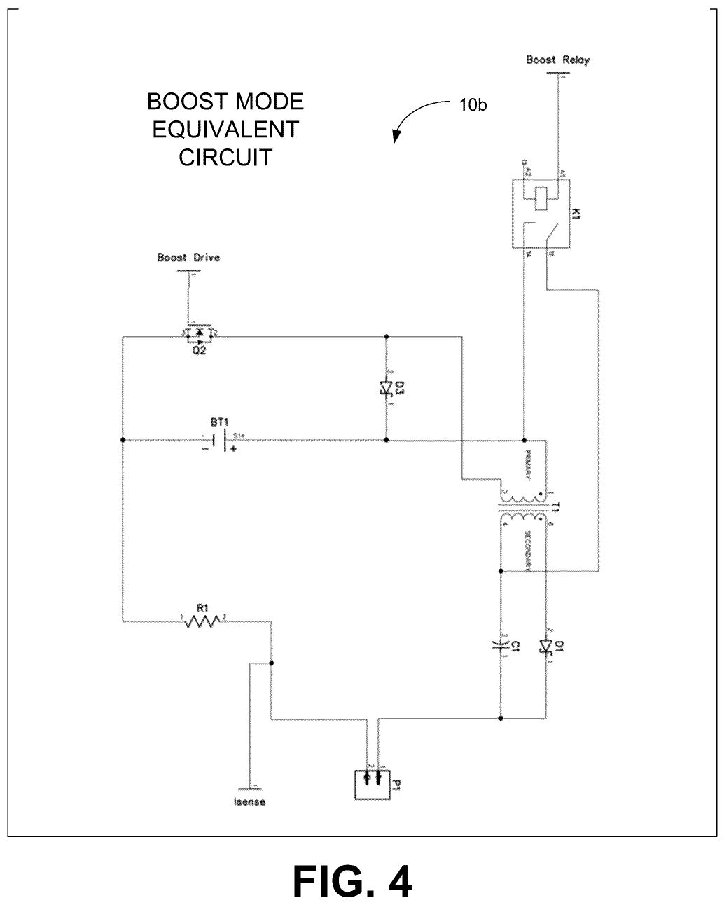

In boost mode, when the recipient voltage is higher, the buck circuit is inactive. FIG. 4 shows the equivalent circuit 10b when the SVBC 10 is in boost mode. Relay K1 closes to allow current to flow from the source into the transformer primary. A signal, preferably but not limited to, a square wave, into transistor Q2 puts pulses of energy into the transformer, inducing a higher voltage in the secondary that adds to the source voltage, causing current to flow. By turning transistor Q2 on and off, the induced secondary voltage can be controlled to add just enough voltage boost to the source voltage so that the recipient battery pack can be charged at the current required (measured by resistor R1).

This can best be explained with an example as follows:
(a) Assume a cycle starts in buck mode, and once the doner and recipient are at the same voltage, there is transition from buck to boost operation, and 70 kW flows directly from source to the recipient via transformer T1, with transistor Q2 being inactive.
(b) The power to the doner should be increased, so transistor Q2 starts to pulse in order to inject energy into the secondary of transformer T1. That energy can be ramped as needed up to 5 kW into the T1 primary, so a total 75 kW flows through the secondary. Therefore, the transformer T1 only needs to handle the differential 5 kW, not the total 75 kW of power. This allows the transformer to be smaller, lighter and lower cost via reduced copper, magnetics, insulation, and no taps.

The SVBC 10 reduces the size, the insulation, the copper, and the magnetics in the transformer, which is required to adapt the voltage of the battery pack from the source battery pack and adapt that voltage over to the recipient EV. In almost all real-world situations, the source battery voltage is different than the vehicle battery voltage. If the two are directly coupled, then the instantaneous currents would be exceedingly high and unacceptable damage would result. So, the SVBC 10 introduces an inductive element that allows energy transfer at different voltages between the source and destination. Depending upon the vehicle charge state and the source charge state, the voltages of the recipient could be higher or lower than that of the source.

The SVBC 10 compensates for both situations. Typically, the grid-connected source battery pack voltage is higher than the recipient EV battery pack voltage. Therefore, the SVBC 10 is designed to obtain the highest energy transfer efficiency for that condition. The SVBC 10 also takes into consideration the fact that next generation EVs will have higher battery voltages, even at a low charge state. The source battery is identified as source battery BT1 in FIG. 2.

A traditional converter 8 of the prior art, which is shown in FIG. 1, has a transformer T2 where the primary and secondary is completely isolated. In this case, energy is pumped into the primary using a metal-oxide-semiconductor field-effect transistor (MOSFET) or other an insulated gate bipolar transistor (IGBT) device to then cause that energy to be transferred to the secondary side.

The secondary side is then diode filtered and goes into the recipient battery. Capacitors are not needed because of the recipient battery is essentially a capacitance. The source battery full power goes through a primary being switched by a high-power transistor going to a secondary which is dumping the transferred power into the EV recipient battery. The transformer handles the difference in voltages between the primary and secondary. In this scenario, the circuit has to have multiple taps on the secondary windings to allow for different voltage ratios and needs to have relays that then switch these multiple taps resulting in a relatively complicated transformer with multi-taps on the receiving side and relays (or high-power transistors) to handle the power transfer.

The SVBC 10 simplifies this architecture by not requiring that the primary and secondary be isolated. When source battery BT1 is at higher voltage than the recipient battery, the circuitry on the left will not be active. The relay K1 is open and the transformer T1 is not part of the circuit. Transistor Q2 is off. There is no energy flowing in transformer T1. And that whole circuitry is disabled. The equivalent circuit 10a for this buck mode is effectively shown in FIG. 3. This mode of operation is well-known without novelty where inductor L2 is handling the full current being transferred.

As an example, consider charging an EV that uses an identical fully charged battery pack voltage as the doners depleted battery. At 74 kilowatts, the system starts in buck mode, and ends in Boost mode as the charge state is inverted.

In buck mode, the inductor L2 would be rated for roughly 200 amps so 200amps of current are passing through circuit elements Q1, L2, D4, and then back to the battery. The resistor R1 is a sensor resistor (for example, 25 micro-ohms) for measuring current flow and regulating that.

Boost mode is where the voltage at transformer T1, the recipient vehicle voltage, is higher than the source battery voltage. With SVBC 10, the transformer T1 does not have to be specified to handle the full 74 kilowatts of charge. All the transformer T1 needs to handle is the additional energy required for the increase in voltage between the source battery BT1 and the recipient battery pack P1. For example, assume that recipient battery pack P1 starts out in its charge cycle at 20 volts higher than BT1. So how is BT1 boosted by 20 volts? The buck drive transistor is turned on and off. So transistor Q1 is now off, and relay K1 is closed. In this case, the entire buck mode logic is electrically out of the circuit. The effective circuit 10b in this mode is shown in FIG. 4. The source battery BT1 current is flowing through the closed relay K1, into the primary of the transformer T1, over to the secondary, and through diode D1 to the recipient. Because the voltage of the recipient battery pack P1 is higher than the voltage of the source battery BT1, initially no current flows.

Current flows by inputting a square wave into the boost drive field effect transistor (FET) Q2. This will put a pulse of energy into transformer T1, resulting in a subsequent pulse of energy in the transformer T1 secondary winding. That energy will then be added to the level of source battery BT1. Essentially, the SVBC induces a voltage into the secondary causing the voltage at diode D1 to exceed the battery voltage and energy starts to flow. So, as a square wave run on transistor Q2, the voltage is boosted into the secondary, causing current to flow in diode D1. The transistor Q2 cannot be left on all the time because the coil would reach saturation and the energy would no longer be transferred. This requires that the boost drive on Q2 be a square wave. So, the boost current is turned on, causing the primary to have current flowing. Once that primary reaches a steady state, (when the inductor has been effectively converted from an inductor into a wire), the inductor is turned off in order to not be losing a lot of energy into transistor Q2. Therefore, as soon as the current starts to decrease in T1, Q2 is turned off, which then effectively removes the current path for transformer T1. When the current path for transformer T1 is removed, it then has flyback, which in turn causes diode D3 to conduct which discharges the current. In essence, this creates a classic switched transistor into an inductor, and so that as transformer T1 leaves its inductive mode, transistor Q2 will be turned off. By constantly monitoring the current in the primary of transformer T1, the transistor Q2 gets turned on and off at a very high rate of speed (probably about 100 to 200 kilohertz). So, the induced secondary power at, for example, 200 kilohertz (kHz), is transferred to the recipient EV battery pack P1.

Another way to conceptualize this boost mode is that the power being conducted through the transformer T1 is added to the positive voltage of the source battery BT1. The current goes from source battery BT1 into the primary and down through transistor Q2 as a means of inducing power into the secondary which has as its initial starting voltage, the voltage of source battery BT1. In essence, the induced energy from SVBC converter is added to the source battery BT1. Assume the source battery BT1 is at 350 V and the EV battery being charged is at 370 V. In this case, there would be 350 V at the top of the T1 secondary with 370 V going out to diode D1, which in turn goes to the vehicle battery P1. In this case, 20 V is added to the battery voltage of 350, which at 200 A, is 4 KW. That 4 KW of additional power is coming from source battery BT1. At the transformer T1 primary, there are two paths for the BT1 battery power. One path is through the boost logic and the other path is into the primary transformer. So, in this example, the bulk of the 70 KW (350 V in the source battery BT1 at 200 A) come directly from the BT1 battery plus an additional 4 KW coming from source battery BT1 via the transformer, while delivering a total of 74 kilowatts to the car (assuming a 100% efficiency converter for explanation simplicity only).

A current of 200 amps is actually conducted through T1, but at effectively 4kW as opposed to 74 KW. So, in this simple example, transformer T1 is actually handling only approximately five percent (˜5%) of the total charging power. That enables a downsizing of the magnetics, copper, and insulation in transformer T1. This in turn enables a smaller, lighter package size, and lower cost.

### Charging Communication Protocol (CCP)

EVSE during DC fast charging involves an industry standard protocol known as the charging communication protocol (CCP). This protocol allows the EV and the charger to exchange information and negotiate the charging parameters to ensure safe and efficient charging. More details of the CCP are as follows:

Initialization: When an EV is plugged into a DC fast charger, the EVSE and the vehicle's onboard systems initiate communication. This typically involves the EVSE sending a request to the vehicle to establish a connection.

Handshake: Once the connection is established, the EV and the EVSE perform a handshake to verify compatibility and exchange basic information, such as the vehicle's make and model, battery capacity, and supported charging rates.

Capability Exchange: After the handshake, the EV and the EVSE exchange information about their respective capabilities and preferences regarding charging parameters. This includes the maximum charging voltage, current, and power levels supported by the vehicle and the charger.

Negotiation: Based on the information exchanged during the capability exchange phase, the EV and the EVSE negotiate the optimal charging parameters for the current charging session. This negotiation takes into account factors, such as the state of charge (SoC) of the recipient battery, the temperature of the recipient battery pack, and any constraints or preferences specified by the user or the vehicle's onboard systems.

Charging Parameters: Once the negotiation is complete, the EV and the EVSE agree on the charging voltage, current, and power level for the charging session. These parameters are then implemented by the EVSE to deliver power to the vehicle's battery pack.

Dynamic Adjustments: Throughout the charging process, the EV and the EVSE may continue to communicate to make dynamic adjustments to the charging parameters based on real-time feedback from sensors and monitoring systems. For example, if the battery temperature increases during charging, the charging current may be reduced to prevent overheating.

Completion and Termination: Once the battery reaches the desired state of charge or the charging session is complete, the EV and the EVSE communicate to terminate the charging process safely. This typically involves gradually reducing the charging current and voltage to prevent overcharging and ensure the longevity of the battery.

### EVSE With SVBC

FIG. 5 is a block diagram showing an example of an implementation of the SVBC 10 in electric vehicle supply equipment (EVSE) 12. In accordance with the CCP, the BMS 14 associated with the EV 16 senses and/or determines the recipient battery voltage of the recipient battery P1 with a battery voltage sensor 18 implemented in hardware and/or software, and this voltage information can be accessed by one or more controllers 22 associated with the EVSE 12 so that the recipient battery voltage can be monitored by the EVSE 12. The EVSE controller 22 also monitors the voltage of the source battery BT1 using a source battery voltage sensor 24, which can be implemented in hardware and/or software. With the source and recipient battery voltages, the EVSE controller 22 can generate the appropriate control signals, Buck Drive, Boost Drive, and Boost Relay for the SVBC 10, as described previously in this invention disclosure in order to charge the recipient battery P1 with the source battery BT1 via the SVBC 10.

### Variations And/Or Modifications

It should be emphasized that the above-described embodiment(s) of the present invention is merely a possible nonlimiting example of an implementation, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

As an example of a variation, those with skill in the art will realize that alternative circuitry is possible to accomplish the buck and boost mode circuitry described herein.

As an example of another variation, the SVBC can be implemented in connection with other systems and apparatus that are not associated with and have no relationship to EVSE.

1. A stepped voltage boost converter (SVBC) for charging a DC recipient battery with a DC source battery, the converter comprising:
a transformer having a primary and a secondary, the primary being electrically coupled to the source battery, the secondary being electrically coupled to the recipient battery;
buck mode circuitry that, when the recipient voltage is lower than the source voltage, enables an electrical current to flow from the source battery into the primary of the transformer; and
boost mode circuitry that, when the recipient voltage is higher than the source voltage, enables both (a) the current to flow from the source battery into the primary of the transformer and (b) an electrical signal to be communicated to the transformer secondary to thereby increase the secondary voltage and therefore current flowing to the recipient battery.

2. The SVBC of claim 1, wherein the electrical signal exhibits a square wave.

3. The SVBC of claim 1, wherein a ratio of the boost mode voltage to buck mode voltage is in a range from 1:1 to 1:3.

4. The SVBC of claim 1, wherein the primary and the secondary of the transformer are not isolated.

5. Electric vehicle supply equipment (EVSE) comprising the SVBC of claim 1.

6. The SVBC of claim 1, further comprising:
the DC source battery;
a battery voltage sensor that measures the voltage of the source battery:
the DC recipient battery;
a battery voltage sensor that measures the voltage of the recipient battery; and
a controller that receives the source and recipient measured voltages and that controls the buck mode circuitry and the boost mode circuitry.

7. A method, comprising the steps of:
providing a DC recipient battery and a DC source battery, the recipient and source batteries exhibiting different voltages; and
electrically coupling the recipient battery and the source battery through a controllable current means connected with a transformer in order to transfer energy between the recipient and source batteries that exhibit different voltages.

8. The method of claim 7, wherein the controllable current means exhibits an inductance that can be made lower and higher based upon when the inductance is in a boost mode and buck mode, respectively, the boost mode being when the recipient voltage is higher than the source voltage, the buck mode being when the recipient voltage is lower than the source voltage.

9. The method of claim 8, wherein the controllable current means further comprises:
buck mode circuitry that, when the recipient voltage is lower than the source voltage, enables an electrical current to flow from the source battery into the primary of the transformer; and
boost mode circuitry that, when the recipient voltage is higher than the source voltage, enables both (a) the current to flow from the source battery into the primary of the transformer and (b) an electrical signal to be communicated to the transformer secondary to thereby increase the secondary voltage and therefore current flowing to the recipient battery.

10. The method of claim 9, wherein the electrical signal exhibits a square wave.

11. The method of claim 9, wherein a ratio of the boost mode voltage to buck mode voltage is in a range from 1:1 to 1:3.

12. The method of claim 9, wherein a primary and a secondary of the transformer are not isolated.

13. A stepped voltage boost converter (SVBC) for charging a DC recipient battery with a DC source battery, the converter comprising:
a transformer having a primary and a secondary, the primary being electrically coupled to the source battery, the secondary being electrically coupled to the recipient battery;
buck mode means for, when the recipient voltage is lower than the source voltage, enabling an electrical current to flow from the source battery into the primary of the transformer; and
boost mode means for, when the recipient voltage is higher than the source voltage, enabling both (a) the current to flow from the source battery into the primary of the transformer and (b) an electrical signal to be communicated to the transformer secondary to thereby increase the secondary voltage and therefore current flowing to the recipient battery.

14. The SVBC of claim 13, wherein the electrical signal exhibits a square wave.

15. The SVBC of claim 13, wherein a ratio of the boost mode voltage to buck mode voltage is in a range from 1:1 to 1:3.

16. The SVBC of claim 13, wherein the primary and the secondary of the transformer are not isolated.

17. Electric vehicle supply equipment (EVSE) comprising the SVBC of claim

12.

18. The SVBC of claim 13, further comprising:
the DC source battery;
a battery voltage sensor that measures the voltage of the source battery:
the DC recipient battery;
a battery voltage sensor that measures the voltage of the recipient battery; and
control means for receiving the source and recipient measured voltages and for controlling the buck mode circuitry and the boost mode circuitry.
